(19) United States
(12) Patent Application Publication
(10) Pub. No.: US 2025/0353085 A1
(43) Pub. Date: Nov. 20, 2025

(54) HIGH SPEED MULTI-AXIS MACHINE TOOL

(71) Applicant: University of Kentucky Research Foundation, Lexington, KY (US)

(72) Inventor: Julius Malte Schoop, Lexington, KY (US)

(21) Appl. No.: 19/280,815

(22) Filed: Jul. 25, 2025

Related U.S. Application Data
(63) Continuation-in-part of application No. 17/861,981, filed on Jul. 11, 2022.
Application No. 17/861,981 is a continuation-in-part of application No. 16/798,007, filed on Feb. 21, 2020, now abandoned.
(60) Provisional application No. 62/810,419, filed on Feb. 26, 2019.

(51) Int. Cl. B23C 1/14; B23C 1/06

(52) U.S. Cl. CPC B23C 1/14; B23C 1/06; B23C 2220/32

(57) ABSTRACT

An apparatus and method are provided for three dimensional cutting of a multi-axis feature into a workpiece that are at least partially characterized by a lack of rotationally symmetrical tools and an ability to produce high aspect ratio (depth to diameter) features using mechanical machining. The apparatus includes a base, a displaceable machine table supported on that base, a displaceable spindle supported on the base adjacent the machine table, a cutting tool held in a chuck carried on the spindle and a control module. The control module includes a controller and a plurality of actuators to provide precise displacement of the machine table, spindle, cutting tool and the workpiece for cutting multi-axis surface features into the workpiece.

### RELATED APPLICATION

This application is a continuation-in-part of U.S. patent application Ser. No. 17/861,981, filed on Jul. 11, 2022, which is a continuation-in-part of U.S. patent application Ser. No. 16/798,007, filed on Feb. 21, 2020, which claims priority to U.S. Provisional Patent Application Ser. No. 62/810,419 filed on Feb. 26, 2019, which are hereby incorporated by reference in their entirety.

### TECHNICAL FIELD

This document relates generally to the field of machining and, more particularly, to a new and improved apparatus and method allowing the cutting of multi-axis features, such as a curved feature, into a workpiece.

### BACKGROUND

Machining of complex aerospace components with high buy-to-fly ratios is currently performed using highly rigid, multi-axis horizontal and vertical machining centers. While the stiffness of these machine tools has been continually optimized, two inherent physical limitations of the milling process itself have limited achievable material removal rates and tolerances.

The first limitation of the milling processes is the need for rotationally symmetrical cutting tools and the associated lack of stiffness in the feed direction. When machining deep cavities or narrow slots, highly unfavorable tool length to diameter ratios need to be employed. Many times, the deflection of the tool due to the cutting forces will exceed the feed per tooth, requiring even lower feeds per tooth and thus very sharp cutting tools in order to avoid rubbing rather than cutting. Thus, the beneficial effects of cutting edge preparation can often not be taken advantage of, as excessive deflection and vibration limit their application on long and slender cutting tools and during finishing operations.

Secondly, the heat generated during machining of advanced aerospace alloys leads to rapid tool wear and poor surface integrity. When it comes to controlling heat, cryogenic cooling has been established as one of the most effective methods, particularly in aerospace alloys. Moreover, ongoing work in academia is demonstrating the ability of cryogenic machining to generate highly desirable surface and sub-surface characteristics, such as compressive residual stresses, nano-crystalline surface layers and increased surface layer hardness. However, milling processes generally require delivery of liquid nitrogen through the rotating spindle and tool, which necessitates the use of expensive rotary unions while introducing significant thermal management issues. Thus, internal cryogenic cooling has several inherent limitations that have limited its adoption in industry. External cryogenic delivery eliminates these problems, but is not readily implemented with high speed rotating tools.

In order to address these shortcomings of the milling process, a new kind of machining process is proposed: High speed, multi-axis shaping. This novel process lends itself to easy-to-implement engineered external cooling and lubrication, and it is capable of producing the same kinds of geometries currently produced on 4 and 5 axis machining centers. However, unlike in the milling process, the tools used for high speed shaping are not rotating at high speed, so they do not need to be rotationally symmetrical. Therefore, more favorable tool geometries can be adopted and external cooling can be effectively applied.

Using state-of-the-art linear direct drive servo motors and nanometer position/velocity feedback, extremely high dynamic performance can now be achieved. Accelerations in excess of 5 Gs and linear/interpolated speeds up to 800 sfm can be achieved. The peak cutting force may exceed 1100 lbf, allowing for high material removal rates, even in high strength aerospace alloys. Since the design of cutting tools is no longer limited by rotational symmetry, it is possible to deliver all of the available cutting power to the tool. Thus, metal removal rates may be more than 10 times higher than in similar milling processes; this makes high speed multi-axis shaping a one-and-done (roughing and finishing) alternative to processes that excel at either finishing (ECM) or roughing (BlueArc). Moreover, the lack of rapidly rotating tools fundamentally changes the geometry of the uncut chip, allowing for avoidance of undesirable chip thinning and ploughing, which are commonly experienced in milling. Thus, product quality/surface integrity are expected to be better and can be controlled more effectively than in milled components.

External cryogenic cooling can be supplied using a closed-loop delivery system, eliminating undesired thermal contraction. Such cooling can be delivered even in deep cavities, allowing for proper cooling and chip evacuation. It should be noted that the high-speed shaping process is by no means limited to cryogenic cooling and can of course also be performed dry, with minimum quantity lubrication or conventional flood cooling.

### SUMMARY

In accordance with the purposes and benefits described herein, a new and improved apparatus, in the form of a multi-axis shaper is provided for the cutting of multi-axis (e.g. curved) features into a workpiece at high peak cutting forces. That apparatus comprises, consists of or consists essentially of: (a) a base, (b) a displaceable machine table supported on the base. (c) a displaceable spindle supported on the base adjacent the displaceable machine table, the spindle including a chuck, (d) a single point cutting tool held in the chuck, and (e) a control module including a controller. The controller is adapted to control operation of: (i) an X-axis actuator adapted to displace the displaceable machine table in an X-axis direction, (ii) a Y-axis actuator adapted to displace the displaceable machine table in a Y-axis direction, (iii) a Z-axis actuator adapted to reciprocate the displaceable spindle and the single point cutting tool in a Z-axis direction, (iv) an A-axis actuator adapted to rotationally index the workpiece on the displaceable machine table about an A-axis, (v) a B-axis actuator adapted to rotationally index the workpiece on the displaceable machine table about a B-axis, and (vi) a C-axis actuator adapted to rotationally index and align the cutting tool about a C-axis during reciprocation of the cutting tool along the Z-axis whereby a multi-axis feature is cut in the workpiece by shaping exclusively through multi-axis linear movement of the displaceable machine table, the workpiece and the displaceable spindle. In some embodiments, the various rotary servo motors may be either geared conventional rotary servo motors or direct drive rotary servo motors.

The base may further include a column supporting the displaceable spindle. The X-axis and Y-axis actuators may be linear direction servomotors. The Z-axis actuator, the A-axis actuator, the B-axis actuator and the C-axis actuator may be rotary servomotors. In accordance with another aspect, a new method of machining a workpiece comprises, consists of or consists essentially of shaping a multi-axis surface feature in the workpiece using only multi-axis linear movement of a single point cutting tool relative to the workpiece. In some embodiments, the method further includes one or more of the following steps:
holding the workpiece in a workpiece holder on a linearly displaceable machine table;
linearly displacing the single point cutting tool along a Z-axis while simultaneously rotationally indexing the single point cutting tool along the Z-axis;
simultaneously displacing or reciprocating the machine table in an X-axis direction to generate a primary cutting stroke;
simultaneously displacing or reciprocating the machine table in a Y-axis direction for perpendicular;
simultaneously rotationally indexing the workpiece on the displaceable machine table about an A-axis; and
simultaneously rotationally indexing the workpiece on the displaceable machine table about a B-axis.

In accordance with still another aspect, a method of cutting a curved, three-dimensional/multi-axis surface feature in a workpiece, comprises, consists of or consists essentially of: (a) holding the workpiece in a workpiece holder on a linearly displaceable machine table, (b) reciprocating a single point cutting tool, held by a displaceable spindle, along a Z-axis in a straight line across the workpiece, (c) simultaneously rotationally indexing the single point cutting tool along the cutting axis, (d) simultaneously displacing the machine table in an X-axis direction, (e) simultaneously displacing the machine table in a Y-axis direction, (f) simultaneously rotationally indexing the workpiece on the displaceable machine table about an A-axis, and (g) simultaneously rotationally indexing the workpiece on the displaceable machine table about a B-axis whereby the curved, three-dimensional/multi-axis surface feature is cut in the workpiece by shaping exclusively through multi-axis linear movement of the displaceable machine table, the workpiece and the displaceable spindle. In most cases, the feature would be aligned with the X-axis to allow for the longer stroke and higher strength of the X axis to enable efficient cutting.

The method may further include using jerk motion control whereby acceleration is applied gradually to the displaceable machine table, the workpiece and the displaceable spindle. The jerk motion is necessarily limited to avoid harmonic vibrations that occur when infinite jerk (immediate acceleration) motion is applied to the proposed multi-axis shaping motion where X reciprocates violently. Infinite jerk would furthermore lead to rapid deterioration of mechanical elements such as linear guide bearings and also cause dramatic back electromotive force (EMF), causing damage to the servo drive's regenerative braking circuit. Thus, in some embodiments, the method further includes applying acceleration to the displaceable machine table and the workpiece at a rate ranging from 500 to 5 m/s³. In some embodiments, the method further includes achieving alignment of a three-dimensional, non-symmetrical cutting tool in the curved, three-dimensional/multi-axis surface feature being cut in the workpiece while avoiding undesired collisions with the workpiece inside the curved, three-dimensional/multi-axis surface feature.

In accordance with yet another aspect, an apparatus for multi-axis shaping comprises, consists of or consists essentially of: (a) a base, (b) a displaceable machine table supported on the base, (c) a displaceable spindle supported on the base adjacent the machine table, (d) a cutting tool held in a chuck on the spindle, (e) a workpiece holder adapted for holding a workpiece, and (f) a control module including a controller adapted to control a plurality of at least five actuators whereby precise relative movement of said displaceable machine table, the workpiece and said displaceable spindle provides for multi-axis linear movement of the cutting tool relative to the workpiece without continuous rotation of the tool relative to the workpiece for three dimensional cutting of a multi-axis feature in the workpiece held in the workpiece holder on said machine table.

In one or more of the embodiments of the apparatus, the control module includes an X-axis actuator that is held on the base and adapted to displace the displaceable machine table in an X-axis direction. In one or more of the embodiments of the apparatus, the control module includes a Y-axis actuator that is held on the base and adapted to displace the displaceable machine table in a Y-axis direction. In one or more of the many possible embodiments of the apparatus, the control module includes a Z-axis actuator that is held on the base and adapted to displace the displaceable spindle in a Z-axis direction toward or away from the machine table.

In one or more of the many possible embodiments of the apparatus, the control module further includes a C-axis actuator adapted to index, rotate and align the cutting tool in the chuck for proper engagement and clearance with the workpiece held on the machine table. In one or more of the many possible embodiments of the apparatus, the control module further includes an A-axis actuator adapted to index the workpiece held on the displaceable machine table. In one or more of the many possible embodiments of the apparatus, the control module includes a B-axis actuator adapted to index the workpiece held on the machine table.

In one or more of the many possible embodiments of the apparatus, the base includes a column supporting the displaceable spindle. The cutting tool includes a single, geometrically defined point. Further, the controller may be configured to produce with the high speed multi-axis machine tool at least one multi-axis surface feature selected from a group consisting of a curved feature, a variable depth slot, a free-form surface and a pocket in the workpiece.

In at least one of the many possible embodiments of the apparatus, the apparatus further includes a cryogenic cooling system for cooling the cutting tool and the workpiece during machining. That cryogenic cooling system may provide external cryogenic cooling using a closed-loop delivery system of a type known in the art.

In accordance with yet another aspect, a new and improved method of machining a workpiece is provided. That method comprises providing for multi-axis linear movement of the cutting tool relative to the workpiece without continuous rotation of the tool relative to the workpiece for three dimensional cutting of a multi-axis feature into the workpiece. In one or more embodiments, the method includes the steps of: (a) displacing a workpiece along an X-axis and a Y-axis, (b) simultaneously displacing a cutting tool along a Z-axis to provide a cutting stroke allowing cutting of a multi-axis surface feature into the workpiece.

In one or more of the many possible embodiments, the method may also include indexing, rotating and aligning the cutting tool during reciprocation of the cutting tool along the Z-axis. In one or more of the many possible embodiments, the method may also include indexing the workpiece during reciprocation of the cutting tool along the Z-axis.

The method may include cutting a curved feature into the workpiece using a single point cutting tool. The method may include cutting a variable depth slot into the workpiece using a single point cutting tool. The method may include cutting a free-form slot into the workpiece using a single point cutting tool. The method may include cutting a pocket into the workpiece using a single point cutting tool. This is accomplished without continuous rotation of the cutting tool.

In one or more of the many possible embodiments of the method, the method may include using a control module, having a controller and controller-controlled actuators to displace the workpiece along the X-axis and the Y-axis and the cutting tool along the Z-axis, in order to control the machining process.

In the following description, there are shown and described several preferred embodiments of the apparatus and the method. As it should be realized, the apparatus and the method are capable of other, different embodiments and their several details are capable of modification in various, obvious aspects all without departing from the apparatus and method as set forth and described in the following claims. Accordingly, the drawing figures and descriptions should be regarded as illustrative in nature and not as restrictive.

### BRIEF DESCRIPTION OF THE DRAWING FIGURES

The accompanying drawing figures incorporated herein and forming a part of the patent specification, illustrate several aspects of the apparatus and method and together with the description serve to explain certain principles thereof.

FIG. 1A is a perspective view of the apparatus adapted for three dimensional cutting of a multi-axis feature into a workpiece with a single point cutting tool.

FIG. 1B is a front elevational view of the apparatus illustrated in FIG. 1A.

FIG. 1C is a left side elevational view of the apparatus illustrated in FIG. 1A.

FIG. 1D is a top plan view of the apparatus illustrated in FIG. 1A.

FIG. 2 is a detailed front elevational view of the displaceable spindle of the apparatus illustrated in FIG. 1.

FIG. 3 is a schematic block diagram of the operation control system of the apparatus set forth in FIG. 1.

FIG. 4 is a schematic view of the various actuators used to position the cutting tool, the machine table and the workpiece.

FIG. 5 illustrates how the cutting tool is incrementally turned or rotated to maintain desired alignment with the workpiece feature being cut and avoid undesired collisions with the workpiece inside the feature.

FIGS. 6-9 are a series of detailed perspective views illustrating a single reciprocal cutting stroke along the positive X-axis. More specifically, FIG. 6 represents the beginning (start of acceleration), FIGS. 7 and 8 represent the occurrence of cutting with FIG. 9 representing the end of the stroke with full deceleration.

### DETAILED DESCRIPTION

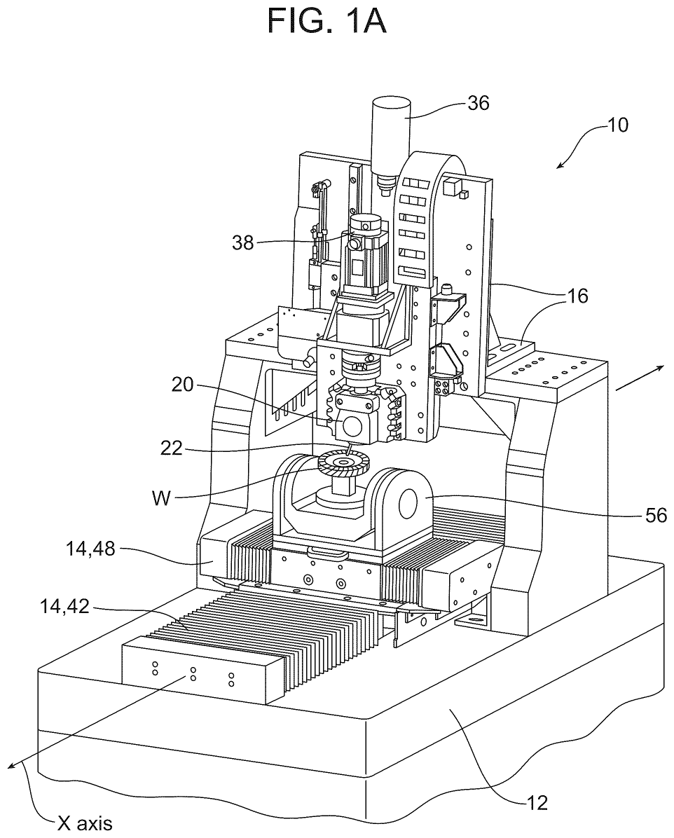

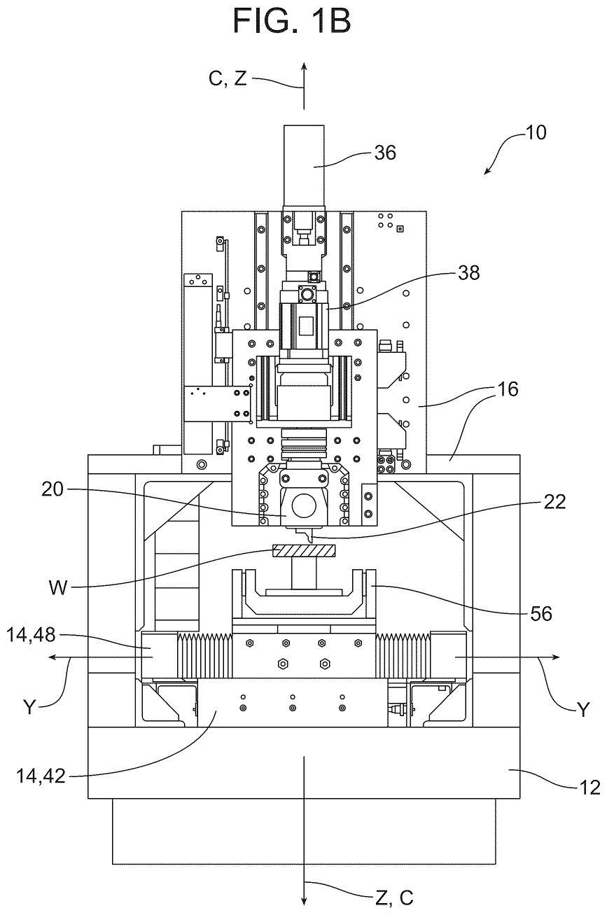

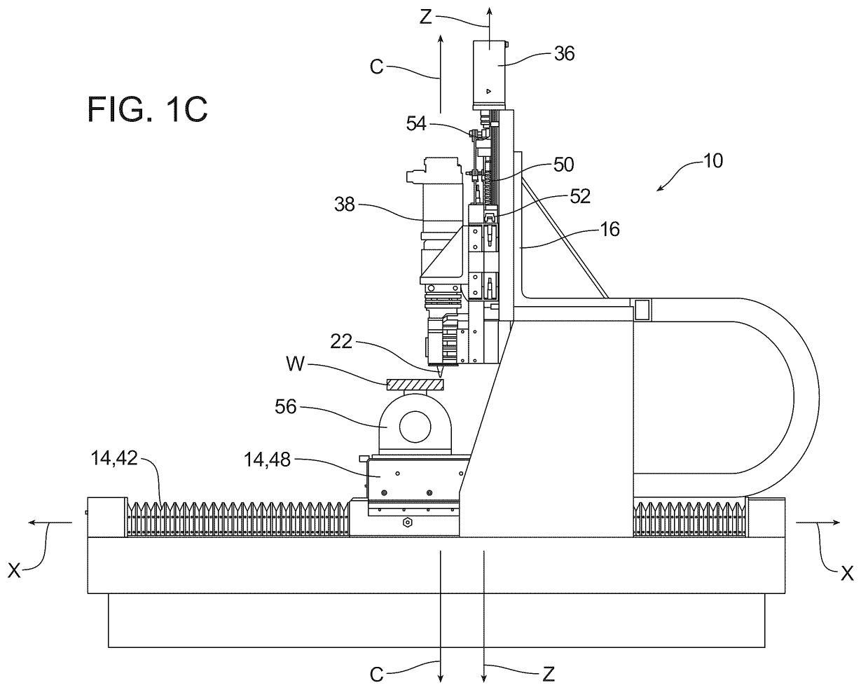

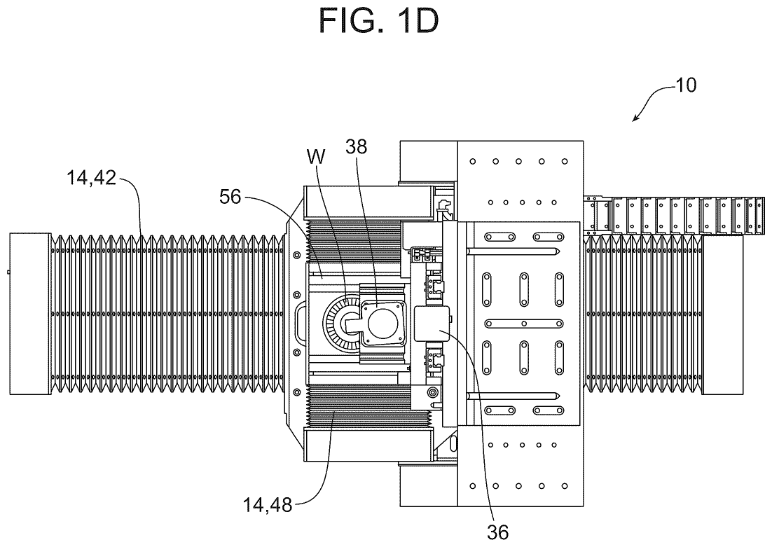

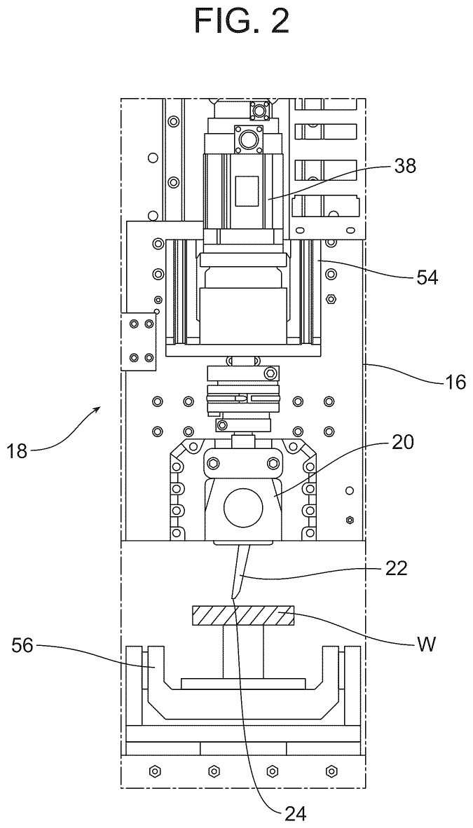

Reference is now made to FIGS. 1A-1D, 2, 3 and 4 that illustrate the new and improved apparatus 10 adapted for the three dimensional cutting of a multi-axis feature into a workpiece W. As illustrated, the apparatus 10 includes a base 12. A displaceable machine table 14 is supported for displacement on the base 12.

The base 12 includes a column 16. A displaceable spindle 18 is supported on the column 16 of the base 12. The spindle 18 includes a chuck 20. A cutting tool 22 is releasably held in the chuck on the spindle. The cutting tool 22 includes a single point 24 for cutting the workpiece W without continuous rotation (i.e. no rotationally symmetrical tool).

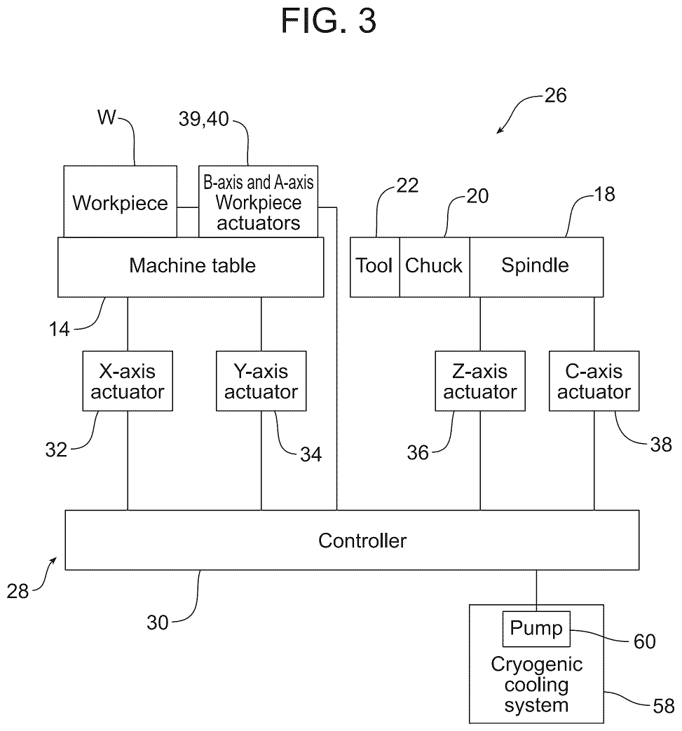

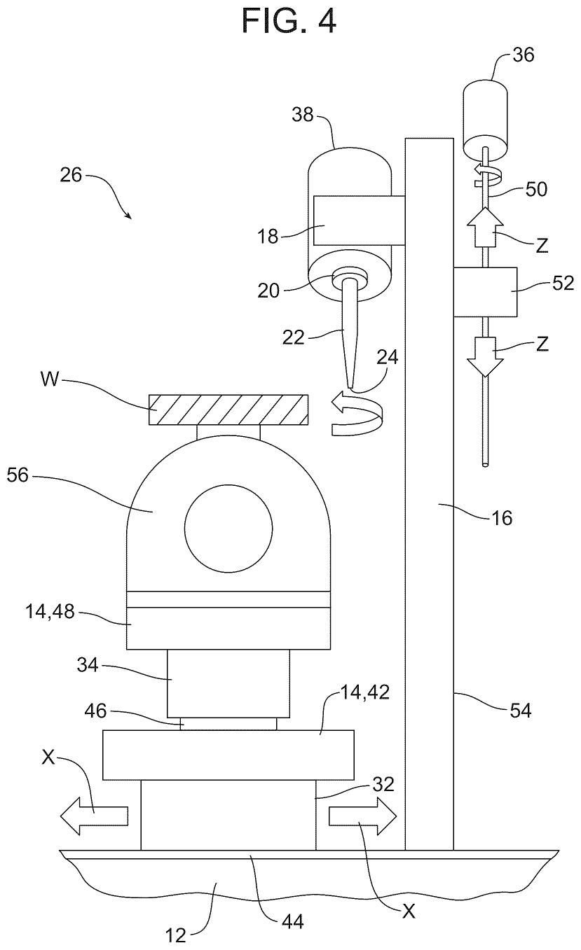

The operation control system 26 of the apparatus 10 is schematically illustrated in FIGS. 3 and 4. The operation control system 26 includes a control module 28. The control module 28 includes a controller 30 adapted to control an X-axis actuator 32, a Y-axis actuator 34, a Z-axis actuator 36, a C-axis actuator 38, a B-axis actuator 39 and an A-axis actuator 40.

More specifically, the controller 30 may comprise a computing device in the form of a dedicated microprocessor or an electronic control unit (ECU) running appropriate control software. The controller 30 may include one or more processors, one or more memories and one or more network interfaces communicating with each other over one or more communication buses.

The various actuators 32, 34, 36, 38, 39 and 40 may comprise state-of-the-art actuators. For example, the X-axis actuator 32 and the Y-axis actuator 34 may comprise linear direction servomotors (for example: SGLFW2 Model linear servomotor from Yaskawa Electric Corporation coupled to an absolute linear encoder system such as the RESOLUTE™ RTLA-S absolute linear encoder system from Reinshaw PLC). The Z-axis actuator 36, the C-axis actuator 38, the B-axis actuator 39 and the A-axis actuator 40 may all comprise rotary servomotors (for example, Yaskawa SGM7A-25A). Using nanometer position and/or velocity feedback between the controller 30 and the actuators 32, 34, 36, 38, 39 and 40, extremely high dynamic performance is achieved.

The X-axis actuator 32 is held on the base 12 and is adapted to displace the displaceable machine table 14 in the X-axis direction (note action arrow X in FIG. 1C). FIG. 4 schematically illustrates the X-axis table 42 supported by the X-axis actuator 32 riding on the magnetic track 44 held on the base 12 (note action arrows X).

The Y-axis actuator 34 rides on the magnetic track 46 supported on the X-axis table 42 and is adapted to displace the Y-axis table 48 of the displaceable machine table 14 in the Y-axis direction (note action arrow Y in FIG. 1B: that is, in and out of the two dimensional view of FIG. 4). The Z-axis actuator 36 is held on the column 16 of the base 12 and is adapted to displace the displaceable spindle 18 in a Z-axis direction toward or away from the displaceable machine table (note action arrow Z in FIGS. 1B and 4). As should be appreciated, the Z-axis actuator moves the cutting tool 22 held in the chuck 20 in a manner defining the cutting stroke of the cutting tool 22. Here, reference is made to FIG. 4 schematically illustrating the rotary servomotor of the Z-axis actuator 36 that rotates the ball screw 50 moving the ball screw nut 52 and the spindle 18 attached thereto along the Z-axis table 54 toward and away from the workpiece W.

The C-axis actuator 38 on the spindle axis along or parallel to the Z-axis, is a rotary servomotor adapted to index, rotate and align the cutting tool 22 held in the chuck 20 for proper engagement and clearance with the workpiece W held on the displaceable machine table 14 (see line C-C in FIGS. 1B and 1C). More particularly, the workpiece W may be firmly held in a workpiece holder, such as the chuck or clamping device 56 of a type known in the art, on the upper face of the machine table 14 or by other appropriate means useful for such a purpose.

The B-axis actuator 39 is a rotary servomotor mounted on the displaceable machine table 14 along a first workpiece axis that runs parallel to the Y-axis Y of the displaceable machine table (see line B-B in FIG. 1B). The A-axis actuator 40 is a rotary servomotor mounted on the displaceable machine table 14 along a second workpiece axis that runs parallel to the X-axis X of the displaceable machine table (see line A-A in FIG. 1C). Both the B-axis actuator 39 and the A-axis actuator 40 are adapted to index the workpiece W on the machine table 14. More particularly, the actuators 39 and 40 rotate the workpiece W into a desired cutting position.

Advantageously, the controller 30 is configured to produce a number of different cutting features in the workpiece W with the cutting tool 22. Those cutting features include, but are not necessarily limited to a curved feature, a variable depth slot, a free-form slot and a pocket. An engineered external cooling and lubrication system 58 may be used to ensure chip clearing, increased tool-life, and thermal stability of the tool, workpiece, and machine tool. Such a system 58 may include, but is not necessarily limited to cryogenic, minimum quantity lubrication, high pressure coolant, and compressed air modalities or combinations thereof. A cryogenic cooling system 58, as schematically illustrated in FIG. 3 may be used to provide cooling to the cutting tool 22 and the workpiece W during the cutting operation. Such a cryogenic cooling system 58 may provide external cooling to the cutting tool 22 and the workpiece W by means of a closed-loop delivery system, of a type known in the art, including a cryogenic fluid circulated by a pump 60 under the control of the controller 30.

Potential applications for this new machine tool are the production of biomedical implants, turbine blades and impellers. All of these high value, high precision components feature geometries that make them difficult-to-machine using conventional multi-axis milling machines. The new apparatus 10 allows for the use of significantly stiffer/more rigid cutting tools, since rotational symmetry is not required. Therefore, material removal rates can be increased by orders of magnitude, while tool-wear, dimensional tolerances and surface integrity (i.e., surface and sub-surface material microstructural changes induced by the cutting process) are all improved significantly. The ability to design and use novel cutting tool geometries in particular allows for much greater control over the geometry of the uncut chip, which allows for much greater control over surface integrity and thus the quality of making components; this is especially meaningful in the context of the potential applications in the biomedical and aerospace industries.

Toward this end, the apparatus 10 may be used in a new and improved method of machining a workpiece W. That method may be broadly described as including the step of providing for multi-axis linear movement of the cutting tool relative to the workpiece without continuous rotation of the tool relative to the workpiece whereby three dimensional cutting of the workpiece is made possible.

To achieve this end, the controller 30 controls the rotational position(s) of ‘A’, ‘B’ and ‘C’ axes and angular or spatial positions X, Y and Z axes of the tool 22 relative to the workpiece W at any point during a coordinate multi-axis movement. While controllers capable of such multi-axis coordinated motion are widely used to achieve 4 and 5-axis machining in turning, milling, and mill/turn processes, it is believed that to date, no such controller has been adapted to achieve multi-axis shaping as currently described in this document.

In order to achieve stable high-speed motion and to limit wear on the motion system due to vibrations and shock, the process uses jerk-controlled motion. Jerk is formally defined as the derivate of acceleration, which is the rate at which acceleration is applied over some limited period of time. Without controlling jerk, acceleration is applied instantaneously, causing high forces and vibrations that prevent stable cutting. Under jerk control, acceleration is applied gradually, reaching the peak acceleration of the system after some limited time. This type of motion is significantly smoother, and thus enables less wear on the machine components, as well as improved cutting dynamics.

The rate at which acceleration is being applied may range from 500 to 5 m/s³ for a system with peak acceleration of 50 m/s², or approximately 5 Gs. For lower peak acceleration values, lighter workpieces, or higher machine stiffness, and higher desired cutting speeds with limited system dimensions, the allowable jerk values will be closer to the maximum of 500 m/s³, while machines with less stiffness, heavier workpieces or higher peak acceleration may require lower jerk values to avoid undesirable vibrations due to the reciprocating machine table providing the primary cutting stroke. It should be noted that higher jerk and peak acceleration settings will reduce process cycle time and the require length of the primary (X) axis, so it is desirable to maximize the quantities to the degree possible based on the achievable stiffness of the machine tool and workpiece/fixture configuration. Controllers that can produce such ‘S curve’ motion are known in the art.

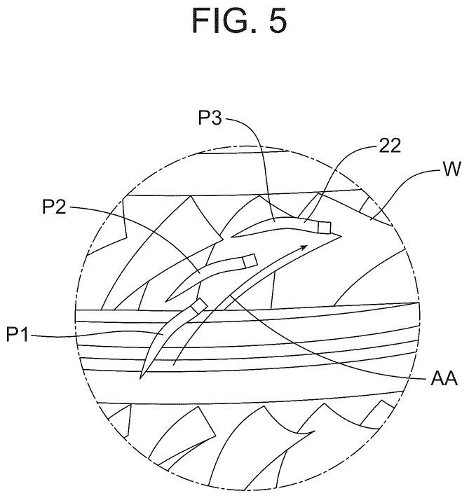

The apparatus 10 and method being described provide coordinate motion of the cutting tool 22, so as to enable precise position and rotation of a complex shaped tool, albeit without continuous rotation (due to lack of axial symmetry of the tool used in the process). The controller 30 will control all of these degrees of freedom, which could reach up to 6 or more independent axes (x,y,z and A,B (rotary) for workpiece, and C (rotary) for tool). The reason for rotating the tool is to achieve alignment of three-dimensional, non-symmetrical cutting tools in curved 3D features, such as slots and pockets. See FIG. 5 illustrating how the cutting tool 22 is incrementally rotated from position P1 to position P2 to position P3 as the tool is moved in the direction of action arrow AA to maintain desired (e.g. tangential) alignment with the workpiece feature being cut and avoid undesired collisions with the workpiece W inside the slot. To do this, the apparatus 10 and method rely on linear or multi-axis movement of the tool 22 relative to the workpiece W. This allows for alignment of the tool body 22 within slots and pockets of a workpiece W that is being machined.

More specifically, the controller 30 coordinates the multiple axes of the machine tool 22, which may be configured in a variety of different manners depending on the specific design of a given machine. In all cases, the controller will coordinate the linear (x,y,z, etc.) and rotary (A,B,C, etc.) axes in such a manner as to control the engagement between the cutting tool 22 and workpiece W in such a manner as to maintain a desired tool/workpiece engagement. Such engagement may be chosen to maintain a constant cross-section of the geometry of the uncut chip, which also results in constant directions of the three main cutting force components during cutting.

In some cases, the engagement may be altered to minimize deflection of either the tool 22 or workpiece W by selecting a tool/workpiece engagement where the cutting forces are primary directed in the stiffest direction of the tool and/or workpiece to minimize undesirable deflections and vibrations. In all cases, the motion of the multiple axes is controlled to avoid collisions between the complex geometry of the cutting tool 22 and associated tool holder body 20, and the workpiece feature being machined. If, for example, a curved slot is being machined with a curved tool, the controller 30 would rotate either the tool 22 or workpiece W, depending on configuration and arrangement of rotary axes, to allow the tool and workpiece to complete a relative motion that avoids collision and rubbing of the tool within the feature being machined. The absence of continuous and rapid rotation of the tool 22 advantageously allows for precise coolant and lubricant (metalworking fluid) application (eliminating centrifugal forces and need for complex and narrow internal coolant channels as used in milling tools), improving process performance and workpiece quality.

The method may include the steps of: (a) displacing a workpiece W along an X-axis X, by means of the X-axis actuator 32, and along a Y-axis Y, by means of the Y-axis actuator 34 and (b) simultaneously displacing a cutting tool 22 along a Z-axis Z, by means of the Z-axis actuator 36, to provide a cutting stroke allowing machining of a three-dimensional surface feature in the workpiece.

As should be appreciated from the above description, the method may also include indexing, rotating and aligning the cutting tool 22, by means of the C-axis actuator 38, during reciprocation of the cutting tool along the Z-axis Z. Further, the method may include indexing the workpiece, by means of the B-axis and A-axis actuators 39, 40, during reciprocation of the cutting tool 22 along the Z-axis Z.

The method may further include the steps of: (a) cutting a curved feature into the workpiece W using a single point cutting tool 22, (b) cutting a variable depth slot into the workpiece W using a single point cutting tool 22, (c) cutting a free-form slot into the workpiece W using a single point cutting tool 22 and/or (d) cutting a pocket into the workpiece W using a single point cutting tool 22.

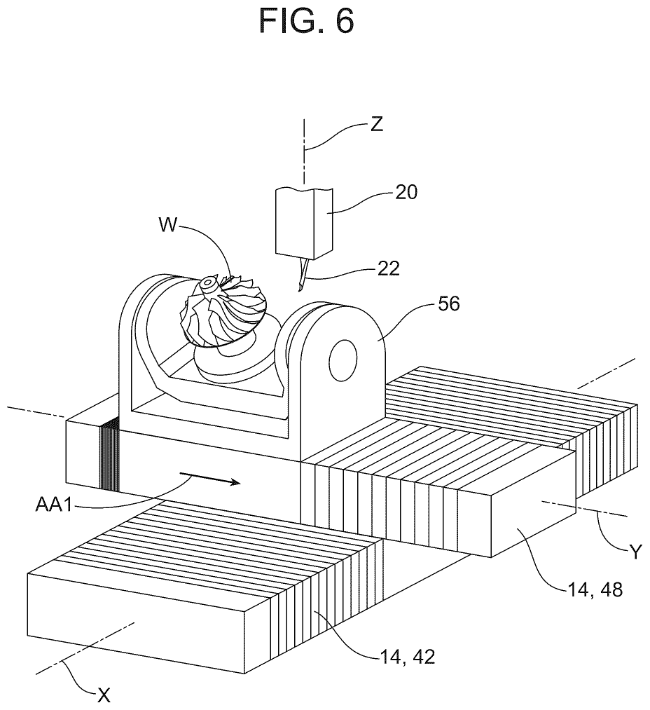

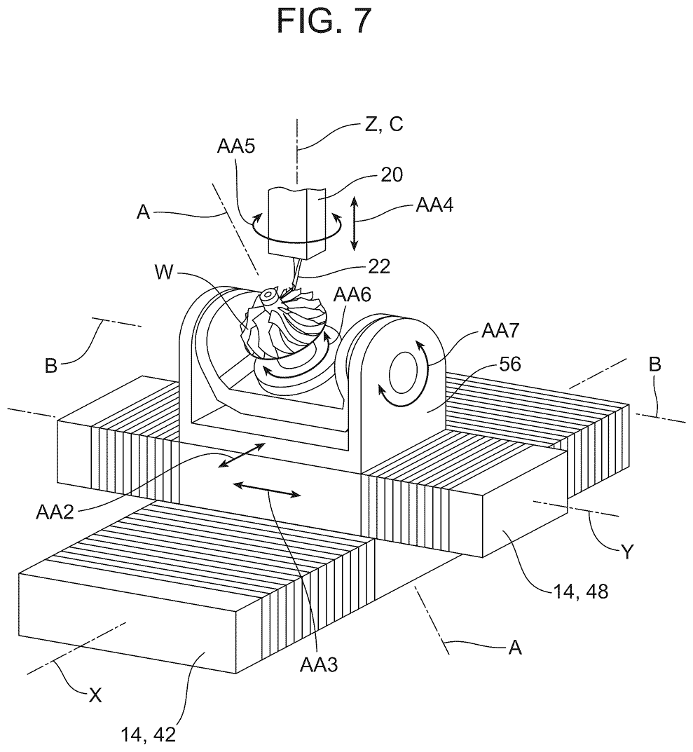

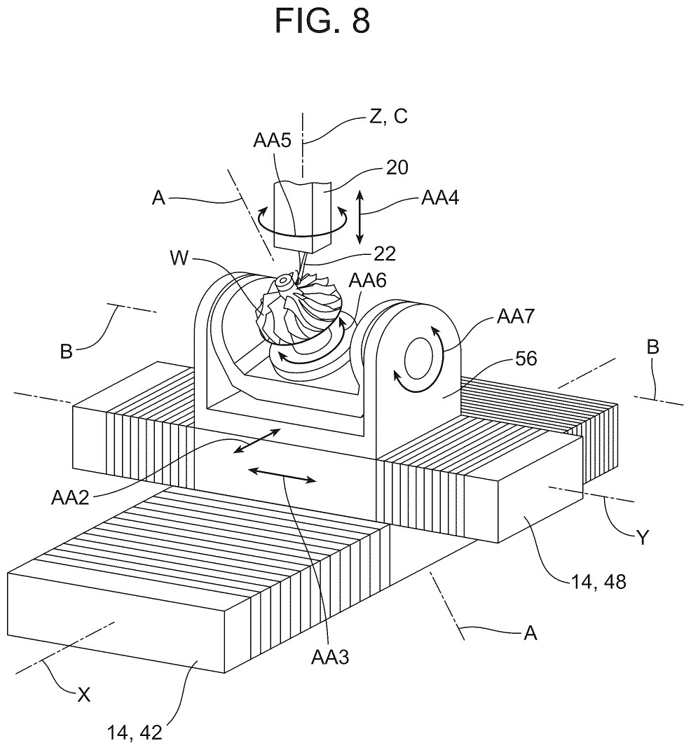

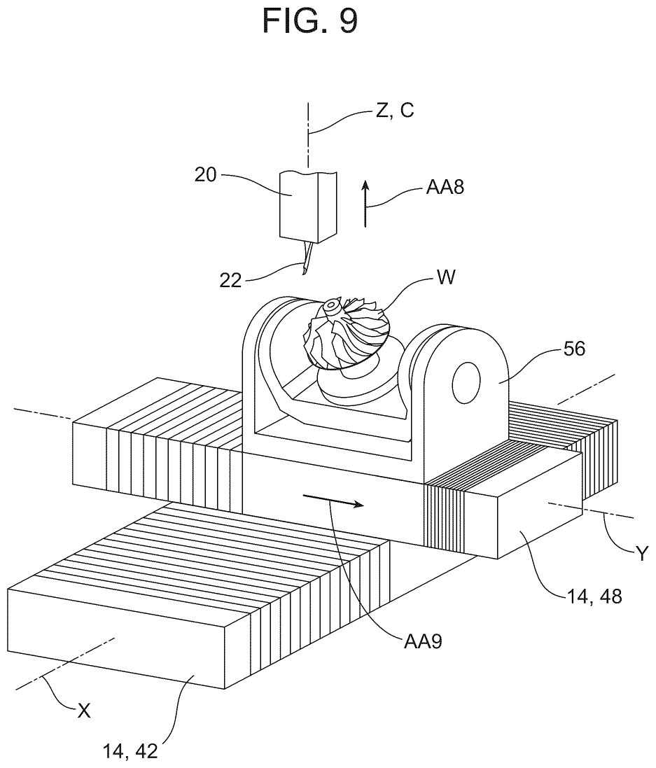

Reference is now made to FIGS. 6-9 which are a series of detailed perspective views that illustrate operation of the apparatus 10 and the new and improved method of machining or multi-axis shaping of a workpiece W exclusively through multi-axis linear movement of the displaceable machine table 14, the workpiece W, and the displaceable spindle 18. More specifically, FIG. 6 represents the beginning of the single reciprocation stroke (start of acceleration) along the X-axis direction. FIGS. 7 and 8 represent the actual cutting. FIG. 9 represents the end of the stroke and full deceleration. After this, the cycle repeats with either a full retraction to the same position shown in FIG. 6, or a stroke in the negative X-axis direction, which would require a roughly 180-degree rotation of the cutting tool 22 to allow for an inverse stroke. The latter is preferred since it limits the amount of non-productive “air cutting” motion.

As illustrated in FIG. 6, the workpiece W, held in the workpiece holder 56 is shifted to the right by operation of the Y-axis table 48 (note action arrow AA1) until the workpiece is aligned under the single point cutting tool 22, held in the chuck 20 aligned with the Z-axis. The workpiece W is then machined by a combination of:
(a) linear motion of the workpiece relative to the cutting tool 22 along the X-axis produced by the linear servomotor actuator 32 (note action arrows AA2 in FIGS. 7 and 8);
(b) linear motion of the workpiece relative to the cutting tool 22 along the Y-axis produced by the linear servomotor actuator 34 (note action arrows AA3 in FIGS. 7 and 8);
(c) linear, reciprocating motion of the chuck 20 and single point cutting tool 22 along the Z axis produced by the linear servomotor actuator 36 (note action arrows AA4 in FIGS. 7 and 8);
(d) rotary motion of the chuck 20 and cutting tool 22 about the Z/C-axis produced by the rotary servomotor actuator 38 (note action arrows AA5 in FIGS. 7 and 8);
(e) rotary motion of the workpiece about the A axis produced by the rotary servomotor actuator 40 (note action arrows AA6 in FIGS. 7 and 8); and
(f) rotary motion of the workpiece about the B axis produced by the rotary servomotor actuator 39 (note action arrows AA7 in FIGS. 7 and 8).

Two or more of any of these motions (a)-(f) may take place simultaneously to ensure the smooth and efficient machining of complicated, curved surfaces. The amount of motion AA5 about the Z/C-axis is limited to 180 degrees during any pass and typically varies no more than 90 degrees or less. Since the cutting action occurs by X or Y-axis linear motion AA2, AA3, the acceleration and deceleration of these axes prevents continuous machining and, instead, requires a non-cutting initial acceleration phase and a deceleration phase after each pass. In this way, the cutting is always intermittent and not continuous. As shown, the z and C axes are co-axial but the cutting tool 22 need not be symmetrical to the C-axis. Of course, an asymmetrical cutting tool 22 would necessarily not have a constant Z-axis intersection as rotation occurs along the C axis.

FIG. 9 then shows the end of this pass with the cutting tool 22 in the chuck 20 being raised above the workpiece (note action arrow AA8) and then the workpiece W being shifted still further to the right (note action arrow AA9).

In summary, numerous benefits and advantages are provided by the apparatus 10 and the associated method of machining a workpiece W. The use of linear servo motors in two perpendicular axes (i.e., the x and y axis of the machine tool) enables accelerations on the order of 10 G and top speeds up to 300 meters per minute. These figures exceed prior shaper tools by orders of magnitude, particularly with respect to the dynamic/interpolated motion capability of the newly developed machine tool. Most importantly, the addition of a secondary (i.e., y) axis enables curved slots to be produced. Addition of a high resolution (˜100 nanometer positioning steps) vertical (i.e., z) axis enables high precision machining at speeds that have so far only been achieved in rotary machine tools, e.g. grinders and state-of-the-art milling machines.

Significantly, the apparatus 10 includes a number of key structural and controller attributes that set it apart from prior art devices:
The machine structure is optimized to exhibit maximum stiffness along the primary cutting axis (x-axis), as well as the vertical (z-axis) dimension to reduce structural resonance (chatter) and enable high-speed reciprocating multi-axis shaping.
Cast iron, natural granite, and epoxy granite composite materials may be used for the base 12 (natural granite and epoxy granite) and structural machine elements (cast iron: table/carriages, Z-axis assembly) to provide maximum material damping and accompanying machining stability.
As the process of multi-axis shaping relies on the increased sectional modulus of tooling without axial symmetry, the entire machine tool and cutting tool system is designed to maximize sectional modulus along the direction of cutting. Complex geometries with deep channels and pockets, such integrally bladed turbine discs (blisks) and molds, require custom-designed tooling to match the geometry of the tool to the specific geometry of the workpiece and avoid collisions during multi-axis coordinated motion of the tool and workpiece.
Jerk-limited (3rd order) motion with gradually applied acceleration and deceleration is important to achieving smooth and chatter-free multi-axis shaping. A machine tool (CNC) numerical controller capable of such complex interpolated motion is required for this machine.
The extreme acceleration and deceleration of the multi-axis shaping process requires linear servo motors with integrated cooling and regenerative braking resistors to avoid overheating and excessive electromotive force during deceleration. Peak accelerations between 1 to 10 Gs are required to achieve productive multi-axis shaping.
The high impact forces experienced not only by the tool 22 and workpiece W, but also the spindle 18 (C-axis) and workpiece (a and b-axes) rotary bearings and servo motors 32, 34, 36, 38, 39, 40 requires high-strength tapered roller and/or oversized angular contact bearings to avoid damage and fatigue of rotating machine elements.
The machine has to be sufficiently heavy and connected to a rigid foundation in order to avoid harmonic resonances. The base made of natural and/or epoxy granite has to be substantially more massive than a conventional milling or turning center to avoid chatter during cutting. For this reason, a solid (rather than ‘skeletonized’) base is preferrable and additional damping mass/ballast in the form of sand, lead pellets, or concrete should be used. Practically, epoxy granite or concrete could be poured into the base on-site during installation to make initial transport and rigging work feasible.

The high speed, multi-axis cutting method disclosed in this document is a newly developed machining process with great application potential across the precision machining industry in sectors including, but not limited to, aerospace, defense, biomedical and mold/die. By virtue of the nature of this new process, several other emerging and existing technologies can finally be leverage to their full potential. Engineered external cooling and lubrication enables improved tool-life and surface integrity, while new tool designs with significantly higher stiffness in the feed direction enable previously unachievable metal removal rates in difficult geometries such as narrow slots and deep cavities/pockets.

The foregoing has been presented for purposes of illustration and description. It is not intended to be exhaustive or to limit the embodiments to the precise form disclosed. Obvious modifications and variations are possible in light of the above teachings. For example, a simplified version of the apparatus 10 could include the X, Y and Z axis linear actuators 32, 34, 36 and the spindle C-axis rotary actuator 38 but no A or B rotary axis actuators 39,40. Such a simple, four axis version could be useful for manufacture of certain prismatic components (e.g. for molds and dies with deep channels and pockets). All such modifications and variations are within the scope of the appended claims when interpreted in accordance with the breadth to which they are fairly, legally and equitably entitled.

What is claimed:

1. An apparatus for multi-axis shaping of a workpiece, comprising:
a base;
a displaceable machine table supported on the base;
a displaceable spindle supported on the base adjacent the displaceable machine table, the spindle including a chuck;
a single point cutting tool held in the chuck; and
a control module including a controller adapted to control operation of:
(a) an X-axis actuator adapted to displace the displaceable machine table in an X-axis direction;
(b) a Y-axis actuator adapted to displace the displaceable machine table in a Y-axis direction;
(c) a Z-axis actuator adapted to reciprocate the displaceable spindle and the single point cutting tool in a Z-axis direction;
(d) an A-axis actuator adapted to rotationally index the workpiece on the displaceable machine table about an A-axis;
(e) a B-axis actuator adapted to rotationally index the workpiece on the displaceable machine table about a B-axis; and
(f) a C-axis actuator adapted to rotationally index and align the cutting tool about a C-axis during reciprocation of the cutting tool along the Z-axis whereby a multi-axis feature is cut in the workpiece by shaping exclusively through multi-axis linear movement of the displaceable machine table, the workpiece and the displaceable spindle.

2. The apparatus of claim 1, wherein the base further includes a column supporting the displaceable spindle.

3. The apparatus of claim 1, wherein the X-axis actuator is a linear direction servomotor.

4. The apparatus of claim 1, wherein the Y-axis actuator is a linear direction servomotor.

5. The apparatus of claim 1, wherein the Z-axis actuator is a rotary servomotor.

6. The apparatus of claim 1, wherein the A-axis actuator is a rotary servomotor.

7. The apparatus of claim 1, wherein the B-axis actuator is a rotary servomotor.

8. The apparatus of claim 1, wherein the C-axis actuator is a rotary servomotor.

9. The apparatus of claim 1, wherein (a) the X-axis actuator is a linear direction servomotor, (b) the Y-axis actuator is a linear direction servomotor, (c) the Z-axis actuator is a rotary servomotor, (d) the A-axis actuator is a rotary servomotor, (e) the B-axis actuator is a rotary servomotor, and (f) the C-axis actuator is a rotary servomotor.

10. A method of machining a workpiece, comprising:
shaping a multi-axis surface feature in the workpiece using only multi-axis linear movement of a single point cutting tool relative to the workpiece.

11. The method of claim 10, further including holding the workpiece in a workpiece holder on a linearly displaceable machine table.

12. The method of claim 11, further including reciprocating the single point cutting tool along a Z-axis while simultaneously rotationally indexing the single point cutting tool along the Z-axis.

13. The method of claim 12, further including simultaneously displacing the machine table in an X-axis direction.

14. The method of claim 13, further including simultaneously displacing the machine table in a Y-axis direction.

15. The method of claim 14, further including simultaneously rotationally indexing the workpiece on the displaceable machine table about an A-axis.

16. The method of claim 15, further including simultaneously rotationally indexing the workpiece on the displaceable machine table about a B-axis.

17. A method of cutting a curved, three-dimensional/multi-axis surface feature in a workpiece, comprising:
holding the workpiece in a workpiece holder on a linearly displaceable machine table;
reciprocating a single point cutting tool, held by a displaceable spindle, along a Z-axis in a straight line across the workpiece;
simultaneously rotationally indexing the single point cutting tool along the cutting axis;
simultaneously displacing the machine table in an X-axis direction;
simultaneously displacing the machine table in a Y-axis direction;
simultaneously rotationally indexing the workpiece on the displaceable machine table about an A-axis; and
simultaneously rotationally indexing the workpiece on the displaceable machine table about a B-axis whereby the curved, three-dimensional/multi-axis surface feature is cut in the workpiece by shaping exclusively through multi-axis linear movement of the displaceable machine table, the workpiece and the displaceable spindle.

18. The method of claim 17, further including using jerk motion control whereby acceleration is applied gradually to the displaceable machine table, the workpiece and the displaceable spindle.

19. The method of claim 18, further including applying acceleration to the displaceable machine table and the workpiece at a rate ranging from 500 to 5 m/s³.

20. The method of 17 including achieving alignment of a three-dimensional, non-symmetrical cutting tool in the curved, three-dimensional/multi-axis surface feature being cut in the workpiece while avoiding undesired collisions with the workpiece inside the curved, three-dimensional/multi-axis surface feature.
